(19) United States
(12) Patent Application Publication
(10) Pub. No.: US 2011/0270684 A1
(43) Pub. Date: Nov. 3, 2011

(54) DECISION-MAKING SYSTEM AND METHOD

(75) Inventor: SAMUEL HOLTZMAN, SARATOGA, CA (US)

(73) Assignee: Ayax Systems, Inc., Redondo Beach, CA (US)

(21) Appl. No.: 12/768,745

(22) Filed: Apr. 28, 2010

(51) Int. Cl. G06Q 30/00; G06F 17/30

(52) U.S. Cl. 705/14.66; 707/733

(57) ABSTRACT

A method and system for providing product recommendations to users. Attributes associated with one or more products for recommendation are displayed. Each attribute is selectable in a simple “drag-and-drop” manner. Along with the displayed attributes, user preference areas (e.g., preference drop zones) that allow users to indicate amounts of user inclination or disinclination for displayed attributes are displayed. Upon viewing the displayed attributes, users can then select at least one attribute for any user preference type. Thereupon, product recommendations are displayed on the basis of selected preferences over the selected product attributes. Potential product purchasers can express preferences in a simple manner from which specific product recommendations can be made.

### BACKGROUND OF THE INVENTION

The present invention relates generally to computer information systems and methods and, more specifically, to computer information systems and methods for decision making and for providing product recommendations.

When individuals engage in a decision-making process to purchase a product, they invariably engage in a process to determine what products are right for them. However, most consumers cannot easily reach such product determination until they a) become familiar with a range of product attributes, b) understand what products are implied by any given setting of such attributes, and, as a result of that process, c) develop personal preferences for specific products in terms of specific attribute settings.

While most purchasers enter the product-selection process with preferences over some attributes already formed, invariably there are many product attributes over which preferences have yet to be formed. Some already-formed preferences may also change as the purchaser learns about the product. Thus, the decision-making process involves examining potentially large amounts of information until product preferences are clearly established.

Many potential purchasers visit online sales venues for information they seek. They visit websites, which with rare exception utilize seller terminology, for product descriptions, and they are required to learn unfamiliar terminology, which makes their task difficult and burdensome.

Purchasers need to form preferences for products beyond the limited ways offered by online sales venues. They might be able to preliminarily select products in which they may be interested, but cannot typically express their preferences beyond that preliminary selection.

There is a need to address one or more of the foregoing disadvantages of conventional systems and methods, and the present invention meets this need.

### BRIEF SUMMARY OF THE INVENTION

Various aspects of a method and system for providing product recommendations to users can be found in exemplary embodiments of the present invention.

In a first embodiment, this method employs a user interface executing on a processing platform to display attributes associated with one or more products that might be recommended to users. Unlike conventional methods, each attribute is selectable by the user in a simple “drag-and-drop” manner.

If, for instance, the user were a prospective college student in search of an academic major (product), an example of user-selectable attribute could be “Library Research”, which might be associated with such a product (college major) as “History”. If, alternatively, the user were a traveler seeking a next destination, another example of an attribute could be “archeological ruins” corresponding to a travel destination product such as Chichen Itzá (major Maya City) in southeastern Mexico.

Along with the displayed attributes, the method of the present invention also displays different user-preference areas (types)—preference drop zones—each representing a different level of user preference. The availability of more than a single preference drop zone allows users to indicate different degrees of user inclination—or disinclination—for each displayed attribute. An advantage of the present invention is that users can express a range of preference types such as “not interested” or “I dislike.” Users can select zero or more attributes for each user-preference type.

Thereupon, the method of the present invention displays product recommendations on the basis of user-selected preferences over the user-selected product attributes. In this manner, and unlike the prior art, potential product purchasers can express preferences in a simple manner, from which specific product recommendations can be made.

Another advantage of the present invention is that users can benefit from being able to safely explore (or “safely play with”) the implications of their preferences and view what products are recommended as their expressed preferences change. Further yet, another advantage is that the present invention can formulate product recommendations based on specific amounts of attributes present in a product.

In a second embodiment, a method by a user interface executing on a processing platform including a processor coupled to a user input device, display, and memory is disclosed. The method includes displaying one or more user preferences indicating an amount of user inclination for the displayed attributes. The method further includes receiving a signal from the user input device that selects a first attribute and a first user preference to indicate that the user likes or dislikes products associated with the first attribute.

The products associated with the selected first attribute are then ranked based on an amount of the first attribute present in each of the associated products. Thereafter, the method displays recommended products for viewing by the user based on said ranking.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 illustrates Product Recommendation (PR) system according to an exemplary embodiment of the present invention.

FIG. 2 illustrates a single-preference drop-zone interface screen shot according to an exemplary embodiment of the present invention.

FIG. 3 illustrates a two-preference drop-zone interface screen shot according to an exemplary embodiment of the present invention.

FIG. 4 illustrates a four-preference drop-zone interface screen shot according to an exemplary embodiment of the present invention.

FIG. 5 illustrates a six-preference drop-zone interface screen shot according to an exemplary embodiment of the present invention.

FIG. 6 illustrates a radio-button interface screen shot according to an exemplary embodiment of the present invention.

FIG. 7 illustrates a product attribute display screen shot according to an exemplary embodiment of the present invention.

FIG. 8 shows a travel destination recommendation screen shot according to an exemplary embodiment of the present invention.

FIG. 9 shows a automobile recommendation interface screen shot according to an exemplary embodiment of the present invention.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that these embodiments are not intended to limit the invention to these specific embodiments. On the contrary, the invention is intended to cover alternatives, modifications, and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

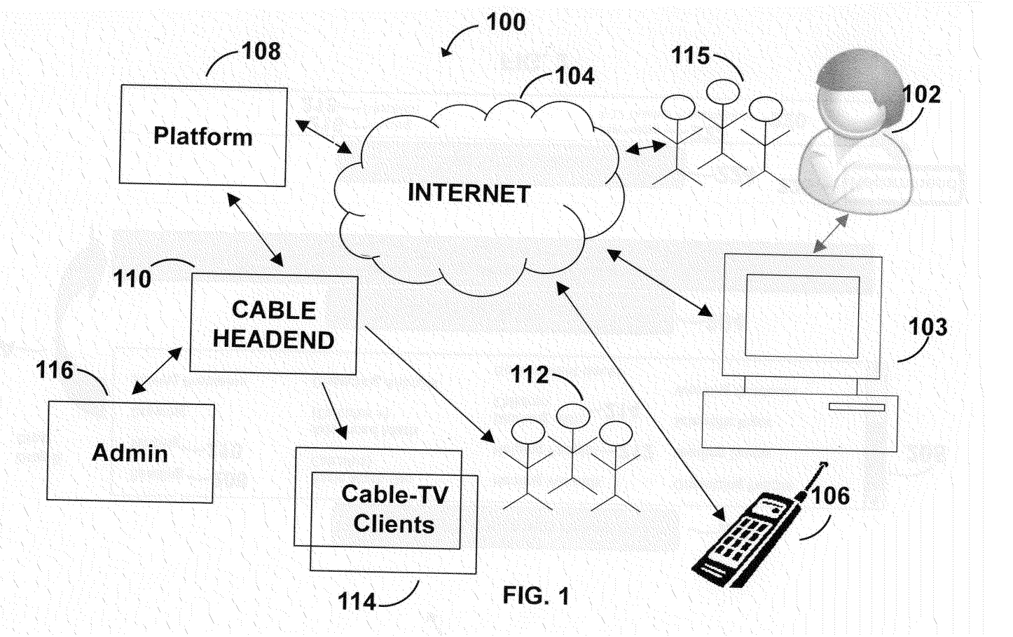

FIG. 1 illustrates Product Recommendation (PR) system 100 according to an exemplary embodiment of the present invention.

In FIG. 1, PR system 100 enables user 102 to receive product recommendations based on the user's own individual preferences. Among other components, PR system 100 comprises platform 108 communicably coupled to computer 103 via Internet 104. Although not shown, Internet 104 represents any distributed network (wired, wireless, or otherwise) for data transmission and receipt between/among two or more points. Here, user 102 might employ computer 103 for access to platform 108. Computer 103 can be any client computing platform executing software instructions via a processor and memory, and having a user interface comprising at least one user input and one user output device.

User 102 might also use mobile communication device 106 for access to platform 108. Mobile communication device 106 may be any wireless, radio, cellular, WiMax, Wifi, etc. device capable of transmitting and receiving voice and/or data communications. PDAs, Smart phones, portable routers, etc. are but examples of mobile communication devices.

Platform 108 is itself a context-free computing platform (e.g., a computer server). This computing platform can provide various instances as proves necessary for implementation of the present invention. For example, platform 108 may be a web server configured to recommend college majors to user 102. In this case, user 102 might be an prospective college student or a college student with an undeclared major. User 102 can browse and examine many options in a simple-yet-powerful manner to assist in the decision-making process for determining a desired college major. This is but an example of the efficacy and broad applicability of the present invention.

Platform 108 might also be configured to recommend automobile models to user 102. In this case, user 102 might be a business person or a university student about to buy a new automobile. User 102 can browse and examine a large number of options in a simple-yet-powerful manner to assist in the decision-making process for determining what automobile to buy. This is but another example of the efficacy and broad applicability of the present invention.

Platform 108 is also configurable to generate product recommendations for other type users, e.g., cable TV viewers 112 via cable head-end 110. Here, platform 108 may provide cable head-end 110 with a product recommendation system framework. Administrators 116 can configure and implement specific instances of the invention (e.g., for different product types) for distribution to internet users 115, cable TV viewers 112, as well as to multiple companies 114.

Companies 114 can be cable-TV clients that are advertising and offering products for sale to consumers. An example of companies 114 might be a digital camera manufacturer and/or a retail outlet. Companies 114 are able to receive user preferences about cable TV viewers 112 or other customers connected through the Internet 115 so that products and/product services can be better geared toward consumer preferences.

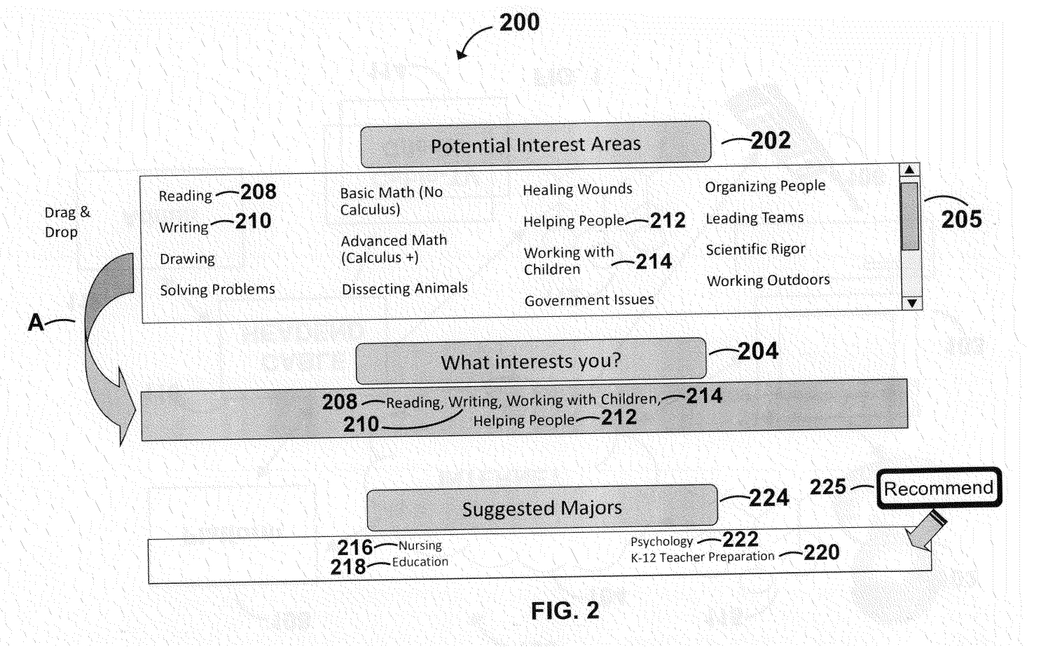

Use and operation of the present invention by user 102 will now be described with reference of FIGS. 2-9 below.

FIG. 2 illustrates a single preference drop-zone interface screen shot 200 according to an exemplary embodiment of the present invention.

In FIG. 2, screen shot 200 allows user 102 (FIG. 1) to select multiple attributes for a single preference type (or single preference area). Product recommendations for the selected attributes can then be displayed by computer 103's display device (FIG. 1) for viewing by user 102. Here, user 102 might be a prospective college student, looking to select a college major. Upon selection of desired attributes, corresponding college majors are recommended and displayed for viewing.

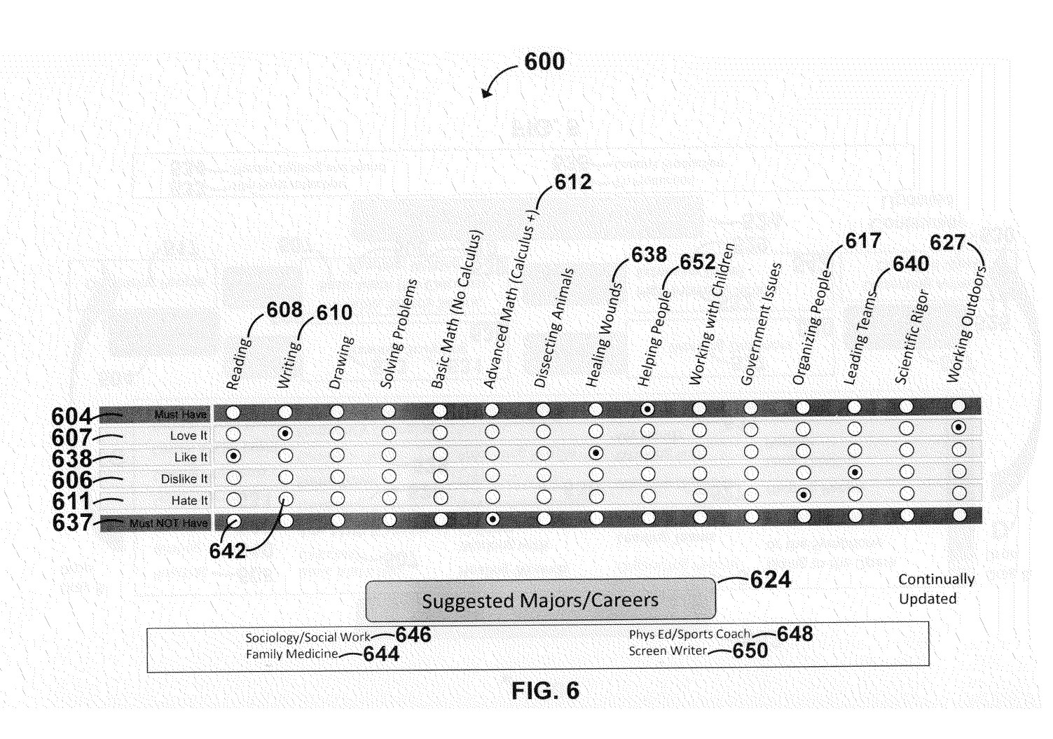

Note that an advantage of the present invention is that screen shot 200 is implemented as an intuitive drag-and-drop GUI (Graphical User Interface). Unlike conventional systems, each attribute is selectable by the user in this simple “drag” and “drop” manner. However, those skilled in the art will realize that other type display interfaces may be employed. As an example, a radio-button bank type interface as further described with reference to FIG. 6 might be utilized.

In FIG. 2, screen shot 200 comprises at least one drag zone namely “Potential Interest Areas” 202 for displaying a plurality of attributes. Screen shot 200 also comprises at least one drop zone or single preference type labeled “What interests you?” 204 for receiving selected attributes. Screen shot 200 further includes a product recommendation display area labeled “Suggested Majors” 224 for displaying recommended products based on the selected product attributes.

It is within the aforementioned “Potential Interest Areas” 202 that a plurality of user-selectable attributes can be found. The term “attributes” simply refers to a characteristic, trait, or feature that a product exhibits, contains, includes, embodies, and/or represents. Specifically as shown in FIG. 2, the selectable user attributes include Reading 208, Writing 210, Helping People 212 and Working with Children 214.

Although not discussed, other attributes such as Drawing or Solving Problems may be displayed. Note that the displayed list of user-selectable attributes is not exhaustive; other attributes within the spirit and scope of the present invention may be applicable. Some of these other attributes may be made visible to the user by scrolling with scroll bar 205.

Reading 208 is an attribute for specifying that a college major involves significant reading. Because the user has dragged attribute “Reading” 108 and dropped it in preference drop zone “What interests you”? 204, attribute “Reading” 208 appears grayed out in drag zone “Potential Interest Areas” 202 to indicate that it has already been dragged and is no longer available for dragging form drag zone “Potential Interests Areas” 202. An example of a college major that sufficiently reflects the attributes dropped in preference drop zone “What interests you”? 204 is Nursing 216 displayed in “Suggested Majors” 224. Attribute “Writing” 210 indicates that a college major involves significant writing. Another example of a major that involves significant writing is Psychology 222. Another example of a college major that sufficiently reflects the attributes dropped in preference drop zone “What interests you”? 204 is Psychology.

Likewise, Helping People 212 is an attribute indicating that a major involves helping people. Another example of a college major that sufficiently reflects the attributes dropped in preference drop zone “What interests you”? 204 is Psychology. Similarly, attribute “Working with Children” 214 would indicate that a selected college major would involve working with children. A final example of a college major that sufficiently reflects the attributes dropped in preference drop zone “What interests you”? 204 is K-12 Teacher Preparation.

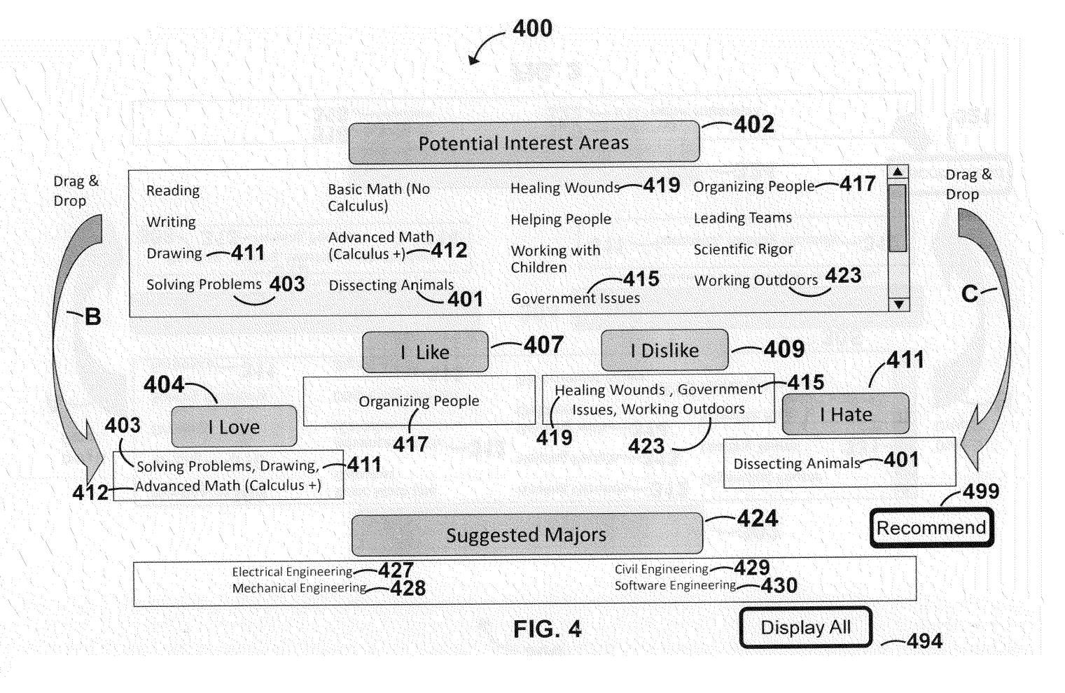

The aforementioned attributes, namely Reading 208, Writing 210, Helping People 212, and Working with Children 214 are selected and dropped in the preference drop zone labeled “What Interests You?” 204. Each attribute is accordingly grayed out in the preference drag zone “Potential Interest Areas” 202 to indicate that the attribute is no longer available for dragging from drag zone “Potential Interest Areas” 202. Unlike other embodiments of the present invention, “What Interests You?” 204 is the only preference type that is available to user 102. A preference type indicates to what degree a user likes or dislikes an attribute. Preference types can be thought of as being on a qualitative continuum and can range from highly negative to highly positive. As an example, as shown in FIGS. 4, 5, and 6, user 102 might “hate” one attribute (highly negative) and “love” a second attribute (highly positive).

Specifically here, screen shot 200 allows a single preference type, namely what is of interest to user 102. By selecting attributes 208, 210, 212, 214 and dropping them in drop zone “What Interests You?,” user 102 indicates a user preference that he or she is “interested” in reading, writing, helping people, and working with children and would be interested in corresponding college majors with said attributes.

Consequently, screen shot 200 uses display area labeled “Suggested Majors” 224 to display recommended college majors that have Reading, Writing, Helping People, and Working with Children attributes. As the contents of “What Interests You?” 204 change and the button “Recommend” 225 is pressed, the contents of “Suggested Majors” 224 are immediately updated.

In operation, user 102 begins by initiating PR system 100. PR system 100 may be initiated by accessing a designated online venue (not shown) served up by PR system 100. Or the system may be activated by selecting a designated startup icon (not shown) on computer 103 (FIG. 1). Once initiated, PR system 100 displays screen shot 200 of FIG. 2, which includes “Potential Interest Areas” 202, “What Interests You?” 204 and “Suggested Majors” 224.

In “Potential Interest Areas” 202, a list of attributes is available for selection by user 102. Specifically, user 102 employs an input device for selecting each of Reading 208, Writing 210, Helping People 212 and Working with Children 214. Here, the selected attributes are dragged from “Potential Interest Areas” 202 to “What Interests You?” 204 via arrow path A, illustrated in FIG. 2.

“What Interests You?” 204 immediately displays in real time these selected attributes that are of interest to user 102. In this manner, user 102 can visually correlate selected attributes and their corresponding recommended products. Unlike prior art systems, user 102 can benefit from being able to safely explore the implications of the user's preferences and view what products are recommended by selecting those preferences.

After a set of desired attributes is selected, it is analyzed by the decision engine contained within PR system 100. Every time the “Recommend” button 335 is pressed, the majors corresponding to the selected attributes are determined and displayed for viewing via Suggested Majors 224. In this manner, the present invention enables a product's potential purchasers to express preferences in a simple manner, from which specific product recommendations are made.

As shown, the displayed majors are Nursing 216, Education 218, Psychology 222 and K-12 Teacher Preparation 220. A determination has now been made that each of the recommended majors sufficiently reflect all of the selected attributes. For example, Nursing 216 involves Reading 208, Writing 210, Helping People 212, and Working with Children 214. Similarly, the other recommended majors, namely Education 218, Psychology 222, and K-12 Teacher Preparation 220 sufficiently include Reading 208, Writing 210, Helping People 212, and Working with Children 214.

In one embodiment, PR system 100 may evaluate the attribute amount for each product. If that attribute amount is below a threshold, the product is not recommended. For example, if a 25% threshold is set, and the amount of Reading 208 found in say Accounting (for example) is below 25%, then Accounting cannot be recommended as a major. This result might occur even if Accounting involves some minimal reading attributes (e.g. 10%), so long as the set threshold is not met.

In an alternate embodiment, different thresholds can be set for different product areas. For example, a 30% threshold might be set for engineering majors while a 65% threshold amount is set for liberal arts majors. Thus, if Reading 208 is below 30% for Electrical Engineering (EE), then EE is not considered for recommendation. Whereas, if Reading 208 is 65% for a Media Communication major i.e., Journalism, then that major is considered for recommendation.

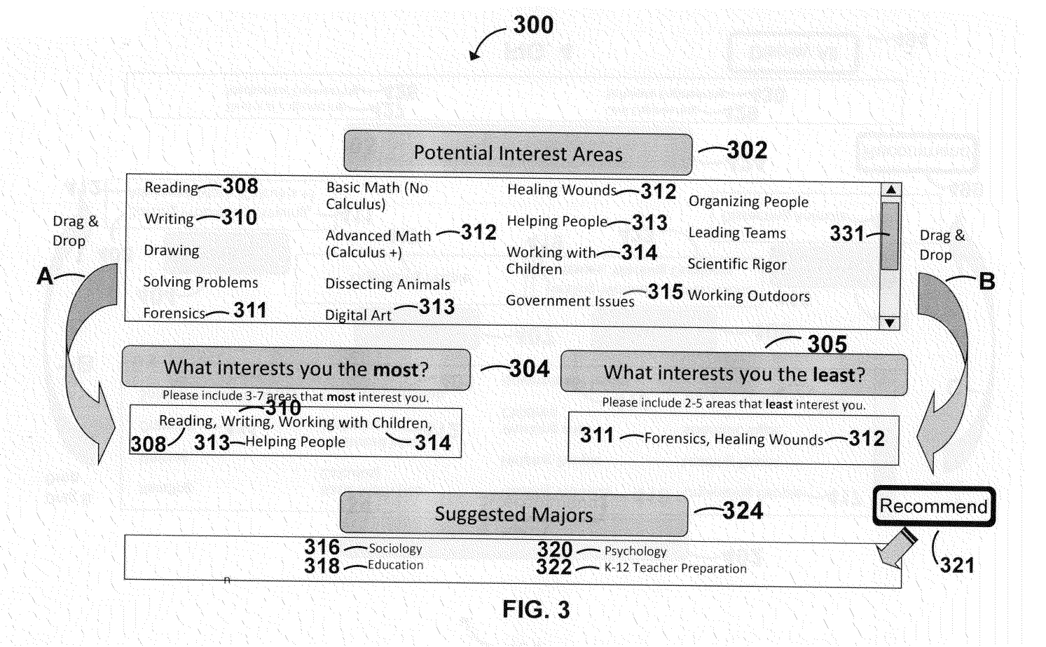

FIG. 3 illustrates a two-preference drop-zone interface screen shot 300 according to an exemplary embodiment of the present invention.

In FIG. 3, user 102 can utilize two preference types or preference drop zones for receiving college-major suggestions. Here, screen shot 300 comprises at least one drag zone, namely “Potential Interest Areas” 302, for displaying a list of selectable attributes, and at least two drop zones or preference types, respectively labeled “What interests you the most?” 304 and “What interests you the least” 305 for dropping the selected attributes. Screen shot 300 further includes display area “Suggested Majors” 324 for displaying suggested college majors.

“Potential Interest Areas” 302 includes user-selectable attributes Reading 308, Writing 310, Advanced Math (Advanced Math+) 312, and Working with Children 314 similar to corresponding attributes of FIG. 2. In addition, attributes Forensics 311, Digital Art 313, and Government Issues 315 are also displayed within “Potential Interest Areas” 302. Attribute Forensics 311 indicates that a college major includes at least some aspects of forensics, Digital Art 313 indicates a college major that might involve digital art and Government Issues 315 applies to college majors that involve government issues. Although not shown, other attributes might be accessible by interacting with scroll bar 331.

The aforementioned Reading 308, Writing 310, Helping People 313, and Working with Children 314 are selected and dropped into drop zone “What interests you the most?” 304. An advantage of the present invention is that unlike the prior art, attributes (Forensics 311, and Healing Wounds 312) can be selected and dropped into a negative preference drop zone, such as “What interests you the least?” 305. In this manner, user 102 can specify attributes that are of least interest to allow recommendations to be further refined and highly tailored to the specific interests/disinterests of users. As a result. Nursing 216, which was suggested in FIG. 2, is replaced by Sociology 316 in FIG. 3.

Specifically here, screen shot 300 allows two preference types namely “What Interests You the Most?” 304 and “What Interests You the Least?” 305. By selecting attributes 308, 310, 313, 314, 311, and 312 and dropping them into their respective preference drop zones 304 and 305, user 102 indicates that he or she is “most interested” in reading, writing, advanced math, working with children and has the “least interest” in forensics and healing wounds. User-selected attributes, whether they have been dropped in positive drop zone “What interests you the most?” 304 or in negative drop zone “What interests you the least?” 305, are grayed out in drag zone “Potential Interest Areas” 302 to indicate that they are no longer available for dragging from drag zone “Potential Interest Areas” 302.

Consequently, screen shot 300 uses display area labeled “Suggested Majors” 324 to display recommended college majors having Reading, Writing, Helping People, and Working with Children attributes with Forensics, and Healing Wounds being weighted negatively. As the content of “What Interests You the Most?” 304 and “What Interests You the Least?” 305 changes, the content of “Suggested Majors” 324 is continuously updated in real time as well and revealed to the user 102 as every time he or she presses the “Recommend button 321.

In operation, user 102 begins by using an input device for selecting each of Reading 308, Writing 310, Helping People 313 and Working with Children 314. Here, user 102 drags the selected attributes from “Potential Interest Areas” 302 to “What interests you the most?” 304 via arrow path A, illustrated in FIG. 3. “What interests you the most?” 304 immediately displays in real-time these selected attributes that are of interest to user 102.

As previously noted, another advantage of the present invention is that users can indicate a negative preference for selected attributes, thereby refining the results for the recommended majors. User 102 next selects attributes Forensics 311 and Healing Wounds 312. The selected attributes are then dragged and dropped via arrow path B into “What interests you the least?” 305. “Suggested Majors” 305 immediately displays in real-time these selected attributes that are of least interest to user 102.

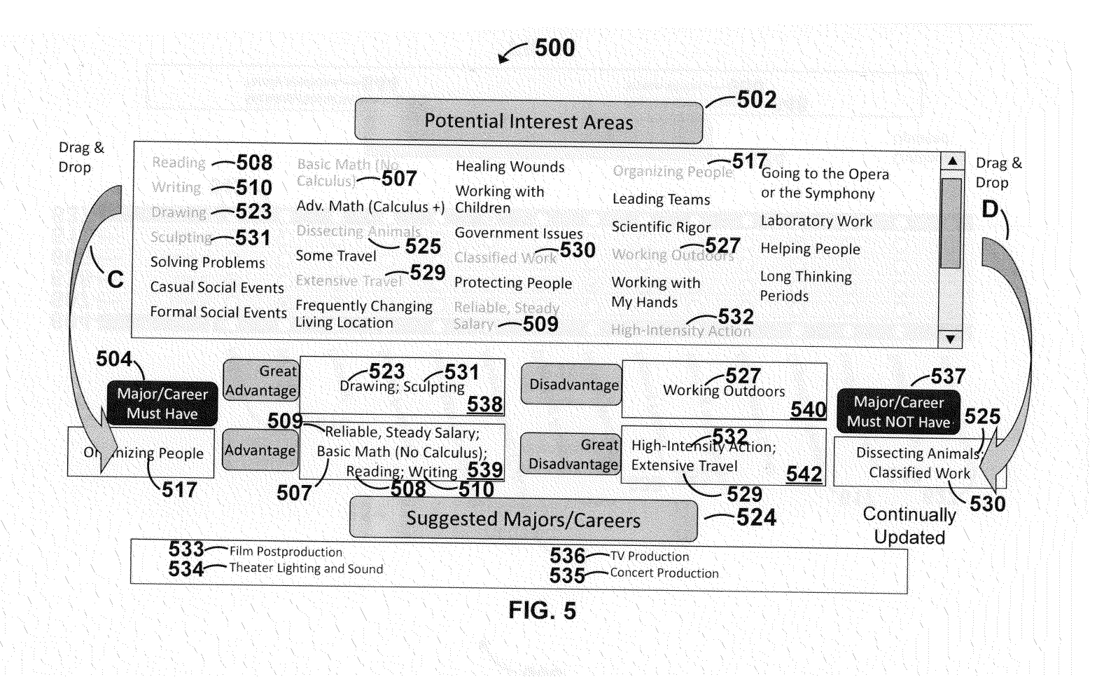

Once attributes are selected and dropped, user 102 may then select “Recommend” button 321 for displaying recommended majors. Alternatively, as FIGS. 5 through 9 show, recommended majors (or other products) may be displayed automatically without need to use the “Recommend” button 321. In that case, PR system 100 is dynamic. As attributes are dropped into respective preference drop zones, recommended majors are displayed in real time.

After recommend button 321 is selected, college majors Sociology 316, Education 318, Psychology 320, and K-12 Teacher Preparation 322, which correspond to the positively and negatively selected attributes are then determine and displayed for viewing via Suggested Majors 324. In this manner, the present invention allows users to further refine and define their product attributes by using negative preferences.

FIG. 4 illustrates a four-preference drop-zone interface screen shot 400 according to an exemplary embodiment of the present invention.

In FIG. 4, user 102 can drop attributes in any or all of four preference types to receive college-major recommendations. Here again, screen shot 400 comprises at least one drag zone, namely “Potential Interest Areas” 402, for displaying a list of selectable attributes. Screen shot 400 further includes a display area labeled “Suggested Majors” 424 for displaying suggested college majors. Unlike other embodiments of the present invention, screen shot 400 further includes four preference types or preference drop zones labeled “I Love” 404, “I Like” 407, “I Dislike” 409, and “I Hate” 411, within each of which selected attributes can be dropped.

In one embodiment, the preference types “I Love” 404, “I Like” 407, “I Dislike” 409 and “I Hate” 411 are weighted such that stronger positive preferences are weighted with a larger positive number than weaker positive preferences, and stronger negative preferences are weighted with a negative of number of larger absolute value than weaker negative preference types. For example, “I Love” 404, which is the highest positive preference selectable by user 102, might be assigned a +3 weighting. At the other extreme, “I Hate” 411, which is the highest negative preference selectable by user 102 might be assigned a negative −3 weighting.

Between both extremes are “I Like” 407, which is assigned a +1 weighting and “I Dislike” 409 that may be assigned a −1 weighting. Thereafter, the assigned weights are used, in part, to score and rank attributes to determine which recommended products are displayed (or displayed first).

In a further embodiment, each product is weighted by the extent to which it exhibits each and every attribute. Typically, the product weightings range from 0 (zero) to 10 (ten). As an example, Mechanical Engineering 428 may comprise the following attributes weighted between 0 and 10 based on the attribute amount characteristic of Mechanical Engineering: Reading 6, Writing 7, Drawing 10, Solving Problems 10, Advanced Math (Calculus +) 10, Dissecting Animals 0, Healing Wounds 0, Helping People 8, Working with Children 2, Government Issues 9, Organizing People 4, Working Outdoors 2, etc.

In operation, user 102 begins by selecting (dragging) and dropping attributes into each of preference drop zones “I Love” 404, “I Like” 407, “I Dislike” 409 and “I Hate” 411. It is preferred that between three to seven attributes be selected. Here, as shown, user 102 selects and drops Solving Problems 403, Drawing 411 and Advanced Math (calculus+) 412 into preference drop zone “I Love” 404, as shown. Since “I Love” 404 is weighted 3, each of Solving Problems 403, Drawing 411 and Advanced Math (calculus+) 412 receives a 3 score.

Next, user 102 might select liked attributes. Specifically, user 102 selects Organizing People 417 and drops that attribute into preference drop zone “I Like” 407. Here, Organizing People 417 is weighted by a 1 weight since “I Like” 407 is weighted 1. Next, user 102 selects disliked attributes, namely Healing Wounds 419, Government Issues 415, and Working Outdoors 423 and drops them into preference drop zone “I Dislike” 409. This results in a −1 weight for each of Healing Wounds 419, Government Issues 415, and Working Outdoors 423 since “I Dislike” 409 is weighted −1. Next, user 102 can select hated attributes. Specifically, user 102 selects and drops Dissecting Animals 401 into “I Hate” 411. Since “I Hate” 411 is weighted −3, Dissecting Animals 411 receives a −3 score.

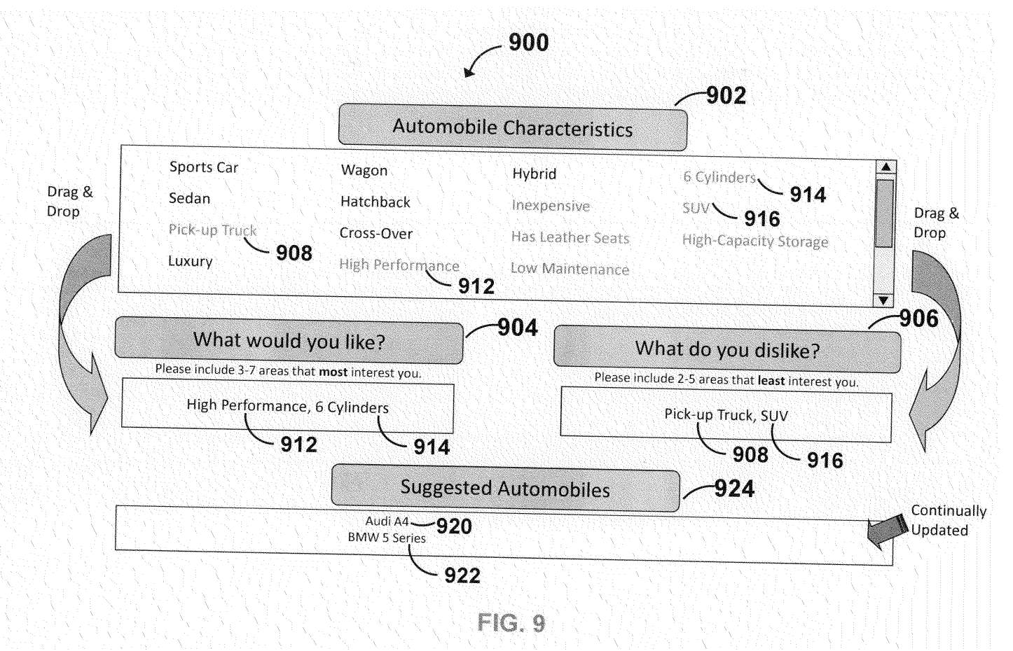

After attribute selection, the recommended majors are determined and then ranked using a correlation matrix based on the preference type and product weighting as further described with reference to FIG. 9, below. A ranking might be obtained for Mechanical Engineering, for example, by obtaining the sum of products of weighted preferences and attributes: Solving Problems (30=3×10)+Drawing (30=3×10)+Advanced Math/Calculus+(30=3+10)+Organizing People (4=1×4) +Healing Wounds (0=−1×0)+Government Issues (−9 =−1×9) etc.

The highest-ranked majors are then displayed (or displayed first). Here, the highest-ranked majors, namely Electrical Engineering 427, Mechanical Engineering 428, Civil Engineering 429, and Software Engineering 430 are displayed within Suggested Majors” 424 for viewing by user 102. Note also that alternatively, or in addition, to displaying only ranked products, user 102 might choose to display all of the recommended products by selecting button Display All 494. User 102 would also employ Recommend button 499 to display recommendations if recommendations are not automatically displayed.

FIG. 5 illustrates a six-preference drop-zone interface screen shot 500 according to an exemplary embodiment of the present invention.

In FIG. 5, user 102 can select six preference types to receive college-major recommendations. All of the college-major recommendations are based on six preference types: four relative-preference types: two likes and two dislikes, and two absolute-preference types a ‘must have’ and a ‘must not have’ preference types with corresponding drop zones.

As shown, screen shot 500 includes a drag zone labeled “Potential Interest Areas” 502 for displaying a list of drag-able attributes. As in prior embodiments, screen shot 500 also includes display area “Suggested Majors” 524 for displaying the college-major recommendations.

Unlike other embodiments of the present invention, screen shot 500 includes six preference drop zones, two of which correspond to absolute-preference types. When attributes are placed (dropped) in the corresponding drop zones, the two absolute-preference types, namely “Must Have” 504 and “Must NOT Have” 537, cause mandatory preclusion of college majors from recommendation. Specifically, college majors not having the selected “Must Have” attributes or having the selected “Must NOT Have” attributes are immediately made unavailable for recommendation.

Screen shot 500 includes two positive relative-preference types or drop zones, namely “Great Advantage” 538 and “Advantage” 539, in which attributes liked by user 102 are dropped. Two negative relative-preference drop zones labeled “Disadvantage” 540 and “Great Disadvantage” 542 are utilized for attributes disliked by user 102.

Here, user 102 initiates the recommendation process by selecting and dropping desired attributes into the appropriate drop zones. Specifically, user 102 drags attribute Organizing People 517 from “Potential Interest Areas” 502 into positive absolute preference drop zone “Must Have” 504 via arrow path C. College majors not having the selected Organizing People 517 attribute are immediately made unavailable for recommendation, and the few having the strongest Organizing People 517 attribute are displayed “Suggested Majors/Careers” 524.

Next, the attributes “Dissecting Animals” 525 and “Classified Work” 530 are dropped into negative absolute preference drop zone “Must NOT Have” 537 via arrow path D. College majors having the selected “Must NOT Have” attributes (“Dissecting Animals” 525 and “Classified Work” 530) are immediately made unavailable for recommendation, and the list in “Suggested Majors/Careers” 524 is adjusted accordingly.

User 102 might then drop Drawing 523 and Sculpting 531 into strong positive relative preference drop zone “Great Advantage” 538. “Great Advantage” 538 simply specifies that the user 102 considers the selected attributes contained therein to offer a great advantage. After the great advantage attributes are specified, user 102 might then drop the following attributes into weak positive relative preference drop zone “Advantage” 539: A Reliable, Steady Salary 509, Basic Math (No Calculus) 507, Reading 508 and Writing 510. Here, “Advantage” 539 indicates that the user 102 considers the selected attributes contained therein to offer an advantage (rather than a great advantage).

User 102 may then drag attribute Working Outdoors 527 from drag zone “Potential Interest Areas” 502 into weak negative relative preference drop zone “Disadvantage” 540. “Disadvantage” 540 simply specifies that the user 102 considers the selected attributes contained therein to offer a disadvantage. Upon selection of disadvantageous attributes, user 102 might then select the attributes considered to be greatly disadvantageous by selecting and dropping Extensive Travel 529 and High-Intensity Action 532 into strong negative relative preference drop zone “Great Disadvantage” 542.

As each attribute is chosen by the user 102 and is selected and dropped into the appropriate preference drop zones, the recommended majors are dynamically determined in real time on the basis of the attributes selected so far. As shown, given the selected attributes shown in FIG. 5, the recommended majors are Film Postproduction 533, Theater Lighting and Sound 534, TV production 536, and Concert Production 535. College major recommendations are continuously updated in real-time as new attributes appear in preference drop zones 504, 538, 539, 540, 542, and 537.

FIG. 6 illustrates radio-button interface screen shot 600 according to an exemplary embodiment of the present invention.

In FIG. 6, screen shot 600 is a radio-button bank allowing user 102 to utilize radio buttons 642 for selecting user preferences. It is thus apparent that the present invention can be implemented using various user interfaces and systems without limitation to any specific implementation.

In FIG. 6, user 102 can select any one of absolute- or relative-preference types “Must Have” 604, “Love It” 607, “Like It” 638, “Dislike It” 606, “Hate It” 611, and “Must NOT Have” 637 for each desired college-major attribute. Any number of preference types may be left unstated if so desired by user 102. As shown, when an attribute's preference type is selected and is, consequently, highlighted, any existing preference-type choice for the same attribute is automatically deselected and un-highlighted.

Here, as shown, user 102 has indicated an absolute positive preference (“Must Have” 604) for attribute “Healing People” 652, thus, healing people must be a significant attribute (aspect) of any recommended college major. Similarly, user 102 has indicated a strong positive relative preference (“Love It” 607) for attributes Writing 610 and

Working Outdoors 627. User 102 has indicated a weaker positive relative preference (“Like It” 638) for attributes Reading 608 and Healing Wounds 638.

User 102 has indicated a negative relative preference (“Dislike It” 606) for attribute Leading Teams 640. In addition, user 102 has indicated a strong negative relative preference (“Hate It” 611) for attribute Organizing People 617. Finally, for attribute Advanced Math (calculus+) 612, user 102 has indicated having an absolute negative preference “Must NOT Have” 637, and, consequently, no recommended college major must have the attribute Advanced Math (calculus+) 612.

Consequently, the following suggested college majors are displayed by display area 624 for viewing by user 102: Sociology/Social Work 646, Family Medicine 644, Phys Ed/Sports Coach 648 and Screen Writer 650. Suggested college majors are continuously updated in real time as corresponding attributes and/or preference types are changed.

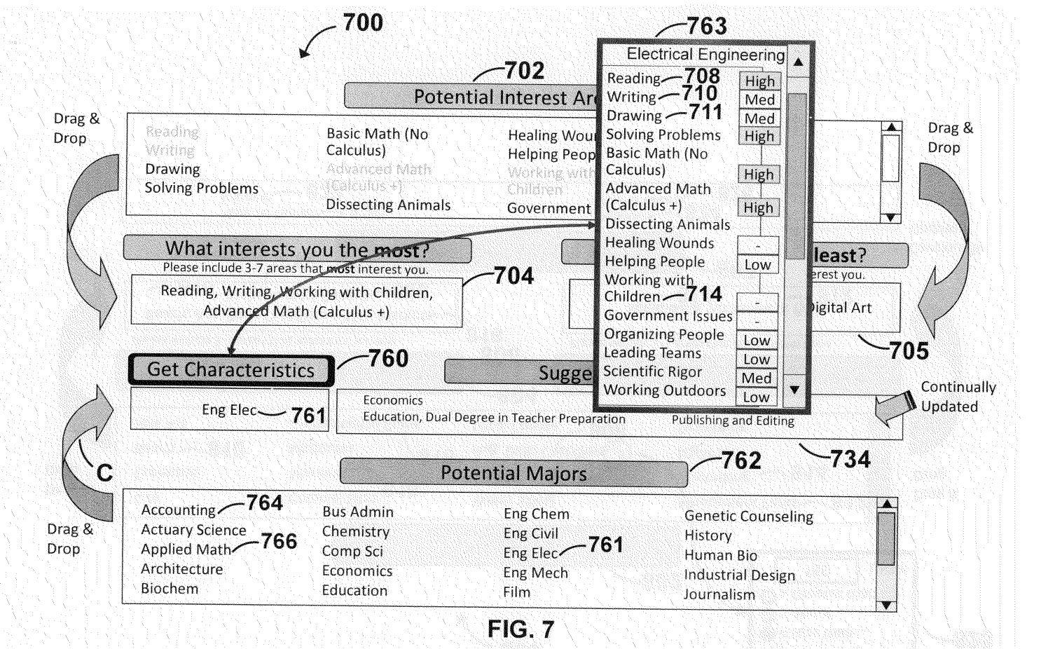

FIG. 7 illustrates product-attribute display interface screen shot 700 according to an exemplary embodiment of the present invention.

In FIG. 7, screen shot 700 allows user 102 to display attributes for a selected college major. Screen shot 700 comprises “Potential Interest Areas” 702, “What Interests You the Most?” 704, “What Interests You the Least?” 705 (partially obscured by offspring window 763) and “Suggested Majors” 734 (partially obscured by offspring window 763) all of which correspond to like-referenced numerals described with reference to FIGS. 2-6.

Screen shot 700 further comprises drag zone “Potential Majors” 762 and drop zone “Get Characteristics” 760. “Potential Majors” 762, which the user can scroll to see additional college majors, includes a plurality of college majors such as Accounting 764, Applied Math 766, Eng. Elec. (Electrical Engineering) 761, etc. Each of the plurality of college majors is selectable by user 102 and can be individually dropped into drop zone “Get Characteristics” 760.

Here, user 102, wishing to determine the particular attributes of electrical engineering, begins by selecting Eng Elec 761 from drag zone “Potential Majors” 762. User 102 proceeds by dropping the selected major into “Get Characteristics” 760 via arrow path C as shown. Once this attribute is dropped, a secondary or offspring window 763 is generated that displays all of the attributes of Eng Elec 761.

Offspring window 763 comprises all product attributes including the qualitative extent to which each attribute is a part of the selected college major. In this display, the extent to which each attribute is part of the selected college major might be low, medium, or high, although other comparable rating levels can be utilized. Here, as shown, Eng Elec 761 includes attributes: Reading 708, Writing 710, Drawing 711 and other attributes as shown.

The attribute level for Reading 708 for Electrical Engineering is high. The attribute level for Writing 710 is medium, and for Drawing 711 is medium. An attribute may be shown with a blank attribute amount level. Thus, Working with Children 714 is not part of Electrical Engineering since that attribute level is blank.

In this manner, this embodiment of the present invention allows users that may be desirous of certain products to examine or investigate characteristics of the desired products. Similarly. User 102 can individually drop any product attribute from Potential Interest Areas 702 into the Get Characteristics 760 drop zone to see an offspring window similar to offspring window 763, which, instead of detailing a product (Elec Enc 761) in terms of its attributes, details the selected attribute in terms of its level—High, Medium, Low, or none—in each product. In this manner, user 102 can benefit from being able to safely explore the implications of his or her preferences and view what products are recommended by specific preferences over the available attributes.

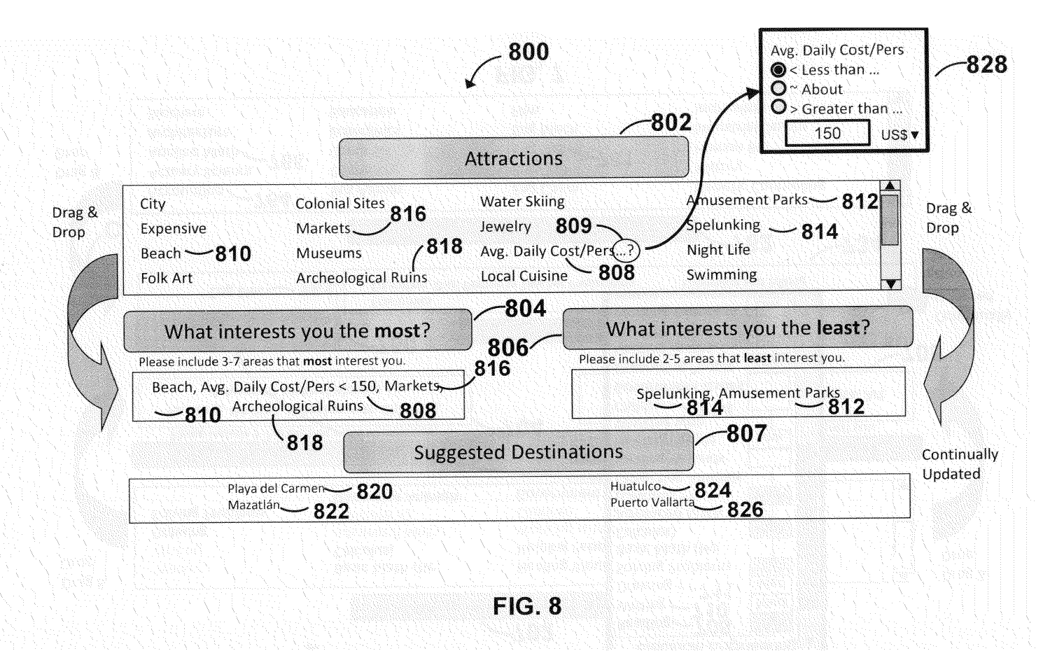

While the above is a complete description of exemplary specific embodiments of the invention, additional embodiments are also possible. For example, the present invention may be implemented to provide recommendations for such products or services as automobiles, digital-cameras, or travel-destinations, the latter of which is as described with reference to FIG. 8, below.

FIG. 8 shows a travel-destination recommendation interface screen shot 800 according to an exemplary embodiment of the present invention.

In FIG. 8, screen shot 800 allows user 102 to receive travel- and vacation-destination recommendations. Among other components, screen shot 800 comprises drag zone “Attractions” 802 for displaying a plurality of site attractions and a display area labeled “Suggested Destinations” 807 for displaying the recommended travel destinations. Screen shot 800 also includes positive and negative relative-preference drop zones, respectively “What interests you the most?” 804 and “What interests you the least?” 806.

Travel destination recommendation is initiated when user 102 selects at least one attraction from drag zone Attractions 802 and drops it in either preference drop zone 804 or 806. Attractions are aspects of and/or activities available at travel destinations, such that they make such a travel destination either more desirable or more undesirable to the user 102. Examples might be whether the travel destination has a beach, archeological ruins, etc.

Here, user 102 initially chooses attractions Beach 810, Markets 816, and Archeological ruins 818 and drops them into drop zone “What interests you the most?” 804. In addition, user 102 selects quantitative value attributes such as “Avg. Daily Cost/Pers<US$150” 808, which express numerical conditions. By placing the quantitative attribute “Avg. Daily Cost/Pers<150” 807 in positive-preference drop zone “What interests you the most?” 804, user 102 is indicating a numerical preference that the typical daily cost per person for a travel destination be less than 150 U.S. dollars.

User 102 specifies a quantitative attribute such as “Avg. Daily Cost/Pers<US$150” 807 by selecting attribute “Avg Daily Cost/Pers?” 808, which is identified as a value attribute by ending in an ellipsis followed by a question mark ‘ . . . ?’ 809 and, upon being selected (dragged), requires that the user 102 reply to a question such as the one asked in dialog box 828. Dialog box 828 allows user 102 to enter a specific amount for the total average daily cost per person. In this case, three radio-button options are provided. One option allows user 102 to select “less than” the total amount entered; option two allows user 102 to select “about” the total amount entered; option three enables user 102 to select “greater than” the total amount entered.

Once an option is selected, the other options are automatically deselected. Also, a pull-down menu is provided allowing user 102 to specify the currency in which the amount is being expressed. Here, as shown, user 102 has entered US$150.00 and has selected the “less than” option, thus, the suggested travel destination should typically cost less than US$150.00 per day. In addition to such numerical-value attributes as “Avg. Daily Cost/Pers . . . ?” 808, user 102 can also specify nominal value attributes (not shown), which are similar to numerical-value attributes except that, instead of requiring that the user 102 specify a numerical value, they require that the user 102 select one or more nominal (text) values from a corresponding list.

After desirable attractions are dropped in positive-preference drop zone “What interests you the most?” 804, undesirable attractions are dropped in negative-preference drop zone “What interests you the least?” 806. Here, user 102 has indicated that he or she is least interested in Spelunking 814 (cave exploration) and Amusement Parks 812 by dragging and dropping these attributes into negative relative-preference drop zone “What interests you the least?” 806.

The qualitative and quantitative attributes dropped by user 102 onto the positive- and the negative-preference drop zones are analyzed by the decision engine of PR system 100 (FIG. 1). Travel destinations corresponding to the selected attractions (attributes) in the corresponding drop zones are then determined and displayed for viewing via “Suggested Destinations” 807. In this case, the suggested destinations are Playa del Carmen 820, Mazatlan 822, Huatulco 824, and Puerto Vallarta 826.

FIG. 9 shows automobile recommendation interface screen shot 900 according to an exemplary embodiment of the present invention.

In FIG. 9, screen shot 900 allows user 102 to receive automobile-purchase recommendations. Among other components, screen shot 900 comprises drag zone

“Automobiles” 902 for displaying a plurality of automobile attributes and a display area labeled “Suggested Automobiles” 924 for displaying the recommended suggested automobile models. Screen shot 900 also includes positive- and negative-preference drop zones “What do you like?” 904 and “What do you dislike?” 906.

Automobile-model recommendation is initiated when user 102 selects an attribute from drag zone Automobiles 902 and places it in either preference drop zone. Specifically, High Performance 912 and 6 Cylinders 914 are dragged from “Automobile Characteristics” 902 to positive-preference drop zone “What do you like?” 904. Pick-Up Truck 908 and SUV 916 are also dragged from “Automobiles” 902 to negative-preference drop zone “What do you dislike?” 906. Consequently, suggested automobile models, namely Audi A4 920 and BMW 5 Series 922 are recommended for purchase and displayed by “Suggested Automobiles” 924 for viewing by user 102.

In one embodiment, product recommendations are derived on the basis of a correlation matrix C={cᵢⱼ} with rows referring to products P={pᵢ} and columns referring to attributes A=aⱼ. In vector notation, C=P×A. Contents of Matrix: cᵢⱼεN; cᵢⱼε[0,10]; cᵢⱼ denotes the extent to which product Pᵢ exhibits attribute aⱼ− with cᵢⱼ=0 denoting “not at all” and Cᵢⱼ=10 denoting “totally”. Each number is referred to as a correlation-matrix value.

Any PR system 100 instance has 1 (one) to 6 (six) preference drop zones, zₖ: specifically 0 (zero) to 4 (four) relative-preference drop zones and 0 (zero) to 2 (two) absolute-preference drop zones. The total number a PR system's preference drop zones is referred to as d. Each drop zone zₖ has an associated weight wₖ, which can be any real number, although a range of between [−10, 10] is preferred.

Let iⱼₖ be an indicator variable such that:

iⱼₖ=1 if and only if user 102 has dropped attribute aⱼ in drop zone zₖ

iⱼₖ=0 otherwise

The preference value V(pᵢ) of each product pᵢ is:

V(pᵢ)=Σ_{j=1,|A|}Σ_{k=1,d}iⱼₖwₖcᵢⱼ

When all V(Pᵢ) are computed, PR system 100 ranks the products pᵢ in decreasing order of V(pᵢ) and displays the labels of the top R products as end-user recommendations, where R is the maximum number of allowed simultaneously recommended products.

While the above is a complete description of exemplary specific embodiments of the invention, additional embodiments are also possible. For example, a logarithmic distribution of preference weights may be appropriate to certain application areas. However, the simple correlation-matrix method described here is the simplest way to assign attribute-based rankings to products. Thus, the above description should not be taken as limiting the scope of the invention, which is defined by the appended claims along with their full scope of equivalents.

I claim:

1. In a computer system having a processing platform including memory, a processor, and a user interface, a method for providing product recommendations to a user, wherein said method displays attributes associated with a plurality of products, said method comprising:
accepting signals from a user input device to select attributes to indicate that the user is not interested in products associated with the selected attributes; and
using said selected attributes indicating that the user is not interested to, in part, display recommended products for viewing by the user.

2. The method of claim 1 wherein the recommended products are displayed by:
assigning low rankings to products associated with the selected attributes, and
displaying said associated products after products associated with nonselected attributes are displayed.

3. The method of claim 1 wherein the recommended products are college majors or travel destinations.

4. The method of claim 1 wherein displayed attributes include reading, writing and solving problems.

5. A method by a user interface executing on a processing platform including a processor coupled to a user input device, display and memory, said method comprising:
displaying a plurality of user-selectable attributes, wherein each of said attributes is associated with one or more products for recommendation to a user;
receiving a first input signal that selects a first attribute to indicate that the user is not interested in products having the selected first attribute;
receiving a second input signal that selects a second attribute to indicate that the user is interested in products having the selected second attribute; and
using the selected attributes including the first attribute and the second attribute to display one or more recommended products for viewing by the user.

6. The method of claim 5 further comprising receiving a third input signal that selects a third attribute to indicate a mandatory user preference specifying that the user must have products associated with the third attribute.

7. The method of claim 6 further comprising receiving a fourth input signal that selects a fourth attribute to indicate a mandatory user preference specifying that the user must not have products associated with the fourth attribute.

8. The method of claim 6 further comprising ranking products associated with the first, second, third and fourth attributes to determine an order of display of recommended products.

9. The method of claim 8 wherein the products are ranked by assigning weights to each of the first, second, third, and fourth attributes.

10. The method of claim 9 wherein the weights are assigned based on the user's preference level for each selected attribute.

11. The method of claim 10 further comprising assigning the weights based on amounts of attribute present in associated products.

12. The method of claim 9 wherein the weighting assigned to each attribute ranges from +3 through −3 inclusive.

13. The method of claim 10 wherein the weighting assigned to each attribute ranges from 1 through 10.

14. The method of claim 5 further comprising:
accepting a user signal to select a product; and
displaying attributes associated with the selected product.

15. A method by a user interface executing on a processing platform including a processor coupled to a user input device, display and memory, said method comprising:
displaying a plurality of attributes selectable by a user, wherein each attribute is associated with one or more products for recommendation to a user;
displaying a plurality of user preferences indicating an amount of user inclination or disinclination for the displayed attributes;
receiving signals from the user input device to select at least one attribute and one user preference indicating the user's preferences for the attribute; and
using the selected attribute(s) and the user preference(s) to display recommended products for viewing by the user.

16. The method of claim 15 wherein a first user preference indicates that the user is not interested in products associated with any one or more attributes.

17. The method of claim 16 wherein a second user preference indicates that the user is interested in products associated with any one or more attributes.

18. A method by a user interface executing on a processing platform including a processor coupled to a user input device, display, and memory, said method including displaying attributes selectable by a user, each attribute being associated with one or more products for recommendation to a user, the method comprising:
displaying one or more user preferences indicating an amount of user inclination or disinclination for the displayed attributes;
receiving a signal from the user input device that selects a first attribute and a first user preference to indicate that the user likes products associated with the first attribute;
ranking the products associated with the selected first attribute based on an amount of the first attribute present in each of the associated products; and
displaying recommended products for viewing by the user based on said ranking.

19. The method of claim 18 further comprising:
receiving a signal to select a second attribute and a second user preference to indicate that the user dislikes products associated with the second attribute;
ranking the products associated with the selected second attribute based on an amount of the second attribute present in each of the associated products ranking.

20. The method of claim 18 further comprising:
receiving a signal to select a third attribute and a third user preference to indicate that the user loves products associated with the second attribute;
ranking the products associated with the selected third attribute based on an amount of the third attribute present in each of the associated products ranking.

21. The method of claim 18 further comprising:
receiving a signal to select a fourth attribute and a fourth user preference to indicate that the user hates products associated with the second attribute;
ranking the products associated with the selected fourth attribute based on an amount of the fourth attribute present in each of the associated products ranking.

22. A computer readable medium configured to store a set of instructions which when executed by a processor of a computer system become operational with the processor, said computer readable medium comprising:
code for displaying a plurality of attributes selectable by a user, wherein each attribute is associated with one or more products for recommendation to a user;
code for displaying a plurality of user preferences indicating an amount of user inclination for the displayed attributes;
code for receiving signals from the user input device to select at least one attribute and at least one user preference indicating the user's preferences for the attribute; and
code for using the selected attribute and the user preferences to display recommended products for viewing by the user.

23. The computer readable medium of claim 22 wherein a first user preference indicates that the user is not interested in products associated with the selected attribute.

24. The computer readable medium of claim 22 wherein a second user preference indicates that the user is interested in products associated with the selected attribute.

25. A computer readable medium configured to store a set of instructions executing on a processing platform including a processor coupled to a user input device, display and memory, said computer readable medium storing code for displaying attributes selectable by a user, each attribute being associated with one or more products for recommendation to a user, the computer readable medium comprising:
code for displaying one or more user preferences indicating an amount of user inclination for the displayed attributes;
code for receiving a signal from the user input device that selects a first attribute and a first user preference to indicate that the user likes products associated with the first attribute;
code for ranking the products associated with the selected first attribute based on an amount of the first attribute present in each of the associated products; and
code for displaying recommended products based on said ranking.

26. The computer readable medium of claim 25 further comprising:
code for receiving a signal to select a second attribute and a second user preference to indicate that the user dislikes products associated with the second attribute;
code for ranking the products associated with the selected second attribute based on an amount of the second attribute present in each of the associated products ranking.
